(19) United States
(12) Patent Application Publication
(10) Pub. No.: US 2021/0188710 A1
(43) Pub. Date: Jun. 24, 2021

(54) FOAMED LIGHTWEIGHT REFRACTORY MONOLITHIC COMPOSITION

(71) Applicant: HarbisonWalker International, Inc., Moon Township, PA (US)

(72) Inventor: Jeff YAKULIS, West Mifflin, PA (US)

(73) Assignee: HarbisonWalker International, Inc., Moon Township, PA (US)

(21) Appl. No.: 16/718,712

(22) Filed: Dec. 18, 2019

(51) Int. Cl. C04B 28/06; C04B 18/14; C04B 14/04; C04B 22/12; C04B 24/38; C04B 24/06; C04B 24/20; C04B 40/00; C04B 38/10

(52) U.S. Cl. CPC C04B 28/06; C04B 18/146; C04B 14/041; C04B 22/126; C04B 2103/304; C04B 24/06; C04B 24/20; C04B 40/0042; C04B 38/10; C04B 24/383

(57) ABSTRACT

A foamed lightweight monolithic refractory castable is provided. The castable includes one or more refractory aggregates as a main constituent, one or more foaming additives in a range of 0.1 wt % to 3.0 wt %, one or more cellulosic powder air-entraining additives in a range of 0.005 wt % to 2.0 wt %, one or more binders in a range of 1 wt % to 40 wt %, and one or more superplasticizers in a range of 0.05 wt % to 0.5 wt %. The refractory aggregates include at least one of alumina and silica. The foaming additives include at least one of alkylbenzene sulfonates, alkene sulfonates, and hydroxylalkane sulfates. The superplasticizers include at least one of sodium polyacrylates, naphthalene sulfonates, polyethylene glycols, polycarboxylates, polyacrylates, and polycarboxylate ethers.

### FIELD OF THE INVENTION

The present invention relates generally to refractory compositions to be applied to the surface of a structure, and, more particularly, to a foamed lightweight monolithic refractory to be applied to the surface of a structure.

### BACKGROUND OF THE INVENTION

Monolithic refractories are commonly used to protect surfaces that are to be exposed to corrosive and high-temperature environments for significant periods. There are a variety of monolithic refractory formulations. Common monolithic refractories are lightweight, strong, and effective as an insulator. Some monolithic refractory formulations have been devised to enable application thereof using particular techniques, such as casting, gunning, ramming, pouring, plastering, pumping, and shotcreting. Other formulations have been devised to address specific environmental challenges and particularly provide resistance to thermal shock, mechanical impact, and certain types of chemical attack. Surfaces on which a monolithic refractory lining may be desired include, but are not limited to, metallurgical vessels, such as furnaces, boilers, ladles, and kilns used in the production of steel. The lightweight monolithic refractories, when cured and dried on the metal vessel, must have physical properties capable of withstanding elevated temperatures, particularly up to 2500° F. and above, for use in high temperature applications, and a corrosive environment.

However, the design and use of lightweight monolithic refractories faces challenges in several respects. For example, perlite, haydite, vermiculite, and similar aggregates are often used in lightweight monolithic refractories for their low densities. On the other hand, these aggregates contain alkalis and iron oxides, which possess relatively lower maximum use temperatures than other aggregates, thereby reducing the refractory ability of a finished product and contaminating the industrial process. Further, particularly in petroleum heaters, when these aggregates remain in the cured, non-heated state for long periods of time within lightweight monolithic refractories, alkaline hydrolysis may occur, thereby resulting in the crumbling of the monolithic refractories into ash that are not immediately put into service. In addition, vermiculite and perlite have lower cold crushing strength, thereby making such aggregates prone to crushing in the field during mixing, which impacts the consistency of finished densities. As such, the applicability of such aggregates is limited to environments in which high cold crushing strength is not required and exposure to relatively high temperature is limited.

Fly ash microspheres, bubble alumina, super lightweight aggregate, and similar aggregates offer more favorable chemistries for higher temperature lightweight monolithic refractories. However, while some of these types of lightweight aggregates can be used with good results, they are relatively costly, which limits their widespread usage in lightweight monolithic refractories. Further, while even the lightest of the monolithic refractories generally cannot compete with insulating fire brick with respect to thermal conductivity, aggregates having favorable chemistries for relatively high temperature environments do not necessarily possess relatively low thermal conductivity characteristics, which is particularly advantageous in such environments. For example, bubble alumina does not provide micron-size porosity in the aggregate, thereby resulting in a relatively higher thermal conductivity than is desired.

Even so, most lightweight aggregates have inherent porosity, thereby additionally requiring lightweight aggregate formulas (e.g., between about 55 lbs/f to 60 lbs/f) to have very high water demands. When a ratio of water to cement is high in a monolithic refractory castable, the strength of the monolithic refractory is compromised.

In addition, pumpability of lightweight monolithic refractory castables for large installations is generally problematic through swing tube style hydraulic shotcrete pumps due to hose plugs that are caused by the inherent porosity of the lightweight aggregates in the lightweight monolithic refractory castables. Thus, lightweight monolithic refractory castables having densities less than 75 lb/ft³ are typically dry gunned. While this type of castable application is commonly used and not necessarily discouraged, dry gunning is a dustier process than shotcreting. Dry gunning also results in greater material loss than shotcreting, as the material does not stick as well in dry gunning as it does in shotcreting. As such, dry gunning is often not available or preferred as an installation option.

The present invention has been developed to address these and other issues by providing a foamed lightweight monolithic refractory in which density is reduced through air entrainment during mixing. This monolithic refractory also is favorable with respect to strength and thermal conductivity values, as high porosity with micron sized pores can be achieved by foaming to reduce or eliminate the need for lightweight aggregates in the monolithic refractory. In addition, the monolithic refractory is able to be applied using various methods.

### SUMMARY OF THE INVENTION

In accordance with an embodiment of the present invention, there is provided a foamed lightweight monolithic refractory castable. The castable includes one or more refractory aggregates as a main constituent, one or more foaming additives in a range of 0.1 wt % to 3.0 wt %, one or more cellulosic powder air-entraining additives in a range of 0.005 wt % to 2.0 wt %, one or more binders in a range of 1 wt % to 40 wt %, and one or more superplasticizers in a range of 0.05 wt % to 0.5 wt %. The refractory aggregates include at least one of alumina and silica. The foaming additives include at least one of alkylbenzene sulfonates, alkene sulfonates, and hydroxylalkane sulfates. The superplasticizers include at least one of sodium polyacrylates, naphthalene sulfonates, polyethylene glycols, polycarboxylates, polyacrylates, and polycarboxylate ethers.

In accordance with another embodiment of the present invention, there is provided a method of applying a foamed lightweight monolithic refractory castable to a surface. The method includes assembling a ready-mix formulation for the foamed lightweight monolithic refractory castable, mixing the ready-mix formulation with water to form the foamed lightweight monolithic refractory castable, and spraying the foamed lightweight monolithic refractory castable onto the surface. The ready-mix formulation includes one or more refractory aggregates as a main constituent, one or more foaming additives in a range of 0.1 wt % to 3.0 wt %, one or more cellulosic powder air-entraining additives in a range of 0.005 wt % to 2.0 wt %, one or more binders in a range of 1 wt % to 40 wt %, and one or more superplasticizers in a range of 0.05 wt % to 0.5 wt %. The refractory aggregates include at least one of alumina and silica. The foaming additives include at least one of alkylbenzene sulfonates, alkene sulfonates, and hydroxylalkane sulfates. The superplasticizers include at least one of sodium polyacrylates, naphthalene sulfonates, polyethylene glycols, polycarboxylates, polyacrylates, and polycarboxylate ethers.

The present invention provides a way by which raw material and costs associated therewith could be saved in ready-mix formulations including air-entraining additives.

The present invention also provides a foamed lightweight monolithic refractory castable that can be pumped through a variety of means without the occurrence of hose plugs.

The present invention additionally provides a foamed lightweight monolithic refractory castable that is stronger due to reduced water requirements leading to smaller pore networks.

The present invention additionally provides a foamed lightweight monolithic refractory castable with a more favorable chemistry to the longevity of the applied castable.

These and other advantages will become apparent from the following description of preferred embodiments taken together with the claims.

### DETAILED DESCRIPTION OF PREFERRED EMBODIMENTS

The following detailed description is provided to assist the reader in gaining a comprehensive understanding of the compositions and methods described herein. However, various changes, modifications, and equivalents of the compositions and methods described herein will be apparent to one of ordinary skill in the art. In addition, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Initially, for purposes of the discussion herein, “apparent porosity” is characterized by the volume fraction of pores (or voids) connected to the surface of a monolithic refractory, i.e. open pores. Generally, monolithic refractories with a high amount of porosity have excellent insulating properties and low density, but also can have low corrosion resistance and strength. Lower porosity improves strength, load bearing capacity, and corrosion resistance, but can lower the thermal shock resistance. The foamed lightweight monolithic refractory described herein is provided to address these trade-offs.

Further, “cold crushing strength”, hereinafter referred to as “CCS”, characterizes the ability of a monolithic refractory to resist fracture or failure under a compressive load at a specific temperature. In an example of the determination of CCS, a compressive load is applied to a monolithic refractory until the refractory fractures or fails. The CCS is calculated by dividing the compressive load applied by the monolithic refractory sample (e.g., lb/in²).

In addition, “modulus of rupture”, hereinafter referred to as “MOR”, characterizes a bending or tensile strength of the monolithic refractory at a specific temperature. In an example of the determination of MOR, a monolithic refractory sample is supported in span. A load is then applied to the monolithic refractory at a specified rate to the center of the monolithic refractory sample until the monolithic refractory sample breaks. The MOR is calculated using the load at which the failure occurred, the span between supports, and a cross-section of the monolithic refractory sample (e.g., lb/in²).

Moreover, “percent linear change”, hereinafter referred to as “PLC”, identifies the occurrence of mineral formations or phase transformations of a monolithic refractory at a specific temperature and dimensional changes experienced by the monolithic refractory as a result thereof. Specifically, the occurrence of mineral formations or phase transformations of a monolithic refractory during high heat exposure may result in linear expansion or reduction. ASTM requirements for ready mix monolithic refractories require a percent linear change between +/−1.5% from the dried state to the maximum use temperature. As such, PLC represents the dimensional stability of a monolithic refractory.

Further, thermal conductivity, which is expressed as K (Btu/hr·ft²·° F./in or W/m·° K), is the amount of heat which flows from a hot face to a cold face of monolithic refractory at a specific temperature. The amount of heat flowing through the monolithic refractory wall is directly proportional to the conductive value of the monolithic refractory, the temperature drop through the monolithic refractory wall, the area of the monolithic refractory wall, and time. The flow of heat through the monolithic refractory wall is inversely proportional to the thickness of the monolithic refractory wall.

In addition, for the purposes of the discussion herein, a “ready-mix formulation” may include a dry powder formulation that is prepackaged and/or bagged and is able to become a castable upon the addition of water.

In view of the above, presented herein is a foamed lightweight monolithic refractory for high temperature applications and a method of applying such a refractory to a metal vessel. Prior to exposure to water and mixing thereafter, the foamed lightweight monolithic refractory is a dry ready-mix formulation. The foamed lightweight monolithic refractory may be applied as a castable on the metal vessel through various wet process means known to those having ordinary skill in the art, including, but not limited to, pouring and various types of spraying, including, but not limited to spraying through a continuous mixer and shotcreting with a rotor stator pump, a ball valve pump, or a swing tube pump. The foamed lightweight monolithic refractory, when hydrated and mixed in castable form, must have a consistency and flow characteristics capable of being applied by these means.

The formulations of the foamed lightweight monolithic refractory are designed in consideration of the characteristics that the foamed lightweight monolithic refractory is desired to possess. Generally, the foamed lightweight monolithic refractory is desired to have a relatively low density, a relatively high AP, a relatively high MOR, a relatively high CCS, and a relatively low PLC. Specifically desired characteristics of the foamed lightweight monolithic refractory may require the composition thereof to be adjusted accordingly.

At the very least, the ready-mix formulation of the foamed lightweight monolithic refractory is comprised of refractory aggregate, one or more foaming additives, one or more powder air entraining additives, and one or more matrix components. The ready-mix formulation of the foamed lightweight monolithic refractory may also include one or more set extenders, one or more superplasticizers, one or more accelerants, and one or more rheology modifiers.

The refractory aggregate may be primarily composed of sources of alumina and silica, such as, but not limited to, aluminum oxides, nesosilicates, phyllosilicates, fireclays, chamottes, bauxites, and silica sands. Examples of aluminum oxides in the refractory aggregate include calcined aluminas, which may include, but is not limited to, tabular aluminas and bubble aluminas. Examples of nesosilicates that could be used in the refractory aggregate may include, but are not limited to, kyanites, mullites, and other nesosilicates having little to no iron oxide or alkali content. Examples of phyllosilicates that could be used in the refractory aggregate may include, but are not limited to, clay minerals, such as pyrophyllites, and other phyllosilicates having little to no iron oxide or alkali content.

The refractory aggregate may also include sources of calcium oxides (e.g., lime), magnesias, and dolomites. Minimal amounts of titania may additionally be present in the refractory aggregate. While occurrences of iron oxides and alkalis may be found in the refractory aggregate, for the above-discussed reasons, every effort is made to ensure that the existence of iron oxides and alkalis in the refractory is very minute or generally inhibited.

Some of the above-referenced materials that may be included in the refractory aggregate are expansive minerals. The expansive minerals that may be included in the refractory aggregate include, but are not limited to, kyanites, pyrophillites, silica sands, dolomites, and magnesias. Expansive minerals serve to inhibit shrinkage and PLC in refractories after exposure to temperatures up to and including 2500° F. In such environments, expansive minerals serve to promote dimensional stability as the foamed lightweight monolithic refractory is heated to such elevated temperatures. The expansive minerals may make up from 5% to 40% of the foamed lightweight monolithic refractory by weight, but preferably may make up from 5% to 20% of the foamed lightweight monolithic refractory by weight.

The foaming additives may include alkylbenzene sulfonates, alkene sulfonates, and hydroxyalkane sulfonates, such as, but not limited to, sodium C₁₄₋₁₆ olefin sulfonate and sodium dodecylbenzene sulfonate. The foaming additives may make up from 0.1% to 3% of the foamed lightweight monolithic refractory by weight, but preferably may make up from 0.1% to 0.5% of the foamed lightweight monolithic refractory by weight. In addition, the foaming additives cannot change or alter the characteristics of the cement or other binders present in the ready-mix formulation.

The powder air entraining additives may include methylcellulose and methylhydroxypropylcellulose. The powder air entraining additives may make up from 0.005% to 2% of the lightweight monolithic refractory by weight, but preferably may make up from 0.025% to 0.5% of the lightweight monolithic refractory by weight. While mainly cellulosic materials are contemplated for air entrainment in the monolithic refractory castable described herein, guar gums, xanthan gums, and inorganic plasticizers such as kaolin, ball, and bentonite clays may also be used to entrain air and stabilize bubbles.

The matrix components may include, but are not limited to, one or more binders, fume silica, reactive alumina, and ball milled and jet milled aggregate. The binders may include, but are not limited to, calcium aluminates. The binders may make up from 1% to 40% of the foamed lightweight monolithic refractory by weight, but preferably may make up from 5% to 40% % of the foamed lightweight monolithic refractory by weight, and more preferably may make up from 10% to 30% of the foamed lightweight monolithic refractory by weight.

Embodiments described herein are not limited to the use of calcium aluminates as the binder, as nearly any air set binder in an aqueous media would be sufficient, including, but not limited to, phosphoric acid air setting mixtures, sodium silicate, and hydratable alumina. Further, while embodiments described herein are primarily directed to ready-mix formulations, when shaped or pre-cast monolithic refractories are used, binders could include, but are not limited to, nylons, acrylics, and other water soluble polymeric binders that require either heat to set or simply air-set.

The amount of refractory aggregate that is necessary for the foamed lightweight monolithic refractory is flexible and dependent on the composition of the matrix components included in the foamed lightweight monolithic refractory. The amount of refractory aggregate in the foamed lightweight monolithic refractory is less of a concern that the total alumina content in the foamed lightweight monolithic refractory. The alumina content of the foamed lightweight monolithic refractory is accumulated from both the refractory aggregate and matrix components, such as, but not limited to, the binder. The alumina content of the foamed lightweight monolithic refractory may be from 30% to 90% of the foamed lightweight monolithic refractory by weight, depending on how pure the refractory is desired to be with respect to the alumina content.

As noted above, the foamed lightweight monolithic refractory may contain other components such, but not limited to, set extenders, superplasticizers, accelerants, and rheology modifiers. The set extenders added to the foamed lightweight monolithic refractory may include acids, such as, but not limited to, citric acid, boric acid, and other acidic compounds. The superplasticizers added to the foamed lightweight monolithic refractory may include dispersants and surfactants, such as, but not limited to, sodium polyacrylate, naphthalene sulfonates, polyethylene glycols, polycarboxylates, polyacrylates, and polycarboxylate ethers. The accelerants added to the foamed lightweight monolithic refractory may include, but are not limited to, lithium fluoride, lithium citrate, lithium carbonate, calcium hydroxide, sodium silicate, or other compounds having a high pH. Rheology modifiers added to the foamed lightweight monolithic refractory may include, but are not limited to, polypropylene fibers, clays, xanthan gyms, and bentonite.

The air entraining additives, such as methylcellulose, are included in the foamed lightweight monolithic refractory as gelling agents to significantly control the finished density of the foamed lightweight monolithic refractory. The air entraining additives serve to stabilize air bubbles formed within the monolithic refractory castable during mixing, thereby counteracting buoyancy to inhibit the escape of air bubbles from the castable. This, in turn, has the effect of increasing the AP of the monolithic refractory, thereby inhibiting thermal conductivity. It also has the effect of lessening the finished density of the foamed lightweight monolithic refractory.

Tables 1 and 2 provided herebelow provide an example of the impact that air entraining additives like methylcellulose have on the AP and the density of foamed lightweight monolithic refractories. As is seen, the achievement of higher AP and lower densities in Examples 3, 4, 7, and 8 is attributable to an amount of methylcellulose by weight that is doubled in the monolithic refractory mix from that which is included in Examples 1, 2, 5, and 6.

TABLE 1

| Examples | 1 | 2 | 3 | 4 | 5 | 6 | 7 | 8 |
|---|---|---|---|---|---|---|---|---|
| 70% Calcium Aluminate | 30 | 30 | 30 | 30 | 20 | 20 | 20 | 20 |
| Cement | | | | | | | | |
| Silica Fume | 10 | 10 | 10 | 10 | 10 | 10 | 10 | 10 |
| 47% Al2O3 Mullite Ball Mill | 30 | 30 | 30 | 30 | 35 | 35 | 35 | 35 |
| 47% Al2O3 Mullite - 35M | 30 | 30 | 30 | 30 | 35 | 35 | 35 | 35 |
| Total | 100 | 100 | 100 | 100 | 100 | 100 | 100 | 100 |

PLUS Admixture

| | | | | | | | | |
|---|---|---|---|---|---|---|---|---|
| Sodium Dodecylbenzene | 0.25 | 0.5 | 0.25 | 0.5 | 0.25 | 0.5 | 0.25 | 0.5 |
| Sulfonate (foaming agent) | | | | | | | | |
| Methylcellulose | 0.1 | 0.1 | 0.2 | 0.2 | 0.1 | 0.1 | 0.2 | 0.2 |
| (air-entraining additive) | | | | | | | | |
| Citric Acid (extender) | 0.1 | 0.1 | 0.1 | 0.1 | 0.1 | 0.1 | 0.1 | 0.1 |
| Sodium Naphthalene | 0.5 | 0.5 | 0.5 | 0.5 | 0.5 | 0.5 | 0.5 | 0.5 |
| Sulfonate (surfactant) | | | | | | | | |
| Lithium Fluoride (accelerant) | 0.05 | 0.05 | 0.05 | 0.05 | 0.05 | 0.05 | 0.05 | 0.05 |

TABLE 2

| Examples | 1 | 2 | 3 | 4 | 5 | 6 | 7 | 8 | Comp. Ex. 1 |
|---|---|---|---|---|---|---|---|---|---|
| Water (%) | 25.3 | 24.1 | 27.3 | 30 | 25 | 22.5 | 27.1 | 29.2 | 54 |
| Self Flow (%) | 95 | 75 | 44 | 68 | 88 | 104 | 40 | 72 | |
| Initial Set (hrs) | 1.8 | 2.9 | 2.2 | 2.4 | 4.2 | 5.1 | 2.6 | 3.5 | |
| Final Set (hrs) | 3.2 | 4.3 | 3.7 | 4 | 6.6 | 7.5 | 5.2 | 6.2 | 4.5 |

After 230° F.

| | | | | | | | | | |
|---|---|---|---|---|---|---|---|---|---|
| Density (pcf) | 58 | 66 | 54 | 58 | 62 | 71 | 57 | 58 | 51 |
| AP (%) | 51 | 46 | 56 | 51 | 47 | 44 | 53 | 51 | |
| MOR (psi) | 200 | 360 | 160 | 240 | 210 | 380 | 100 | 170 | 120 |
| CCS (psi) | 630 | 1140 | 390 | 590 | 550 | 1280 | 270 | 490 | 300 |

After 1500° F.

| | | | | | | | | | |
|---|---|---|---|---|---|---|---|---|---|
| Density (pcf) | 56 | 63 | 52 | 56 | 59 | 69 | 55 | 56 | 49 |
| AP (%) | 57 | 55 | 66 | 60 | 54 | 46 | 63 | 55 | |
| MOR (psi) | 150 | 240 | 100 | 130 | 120 | 280 | 50 | 100 | 80 |
| CCS (psi) | 380 | 540 | 180 | 350 | 320 | 630 | 130 | 180 | 250 |
| PLC (%) | −0.84 | −0.94 | −0.98 | −0.91 | −0.53 | −0.6 | −0.68 | −0.49 | −0.35 |

All of the foamed examples in Tables 1 and 2 require less water for mixing than does the conventional non-foamed 2300° F. low-iron insulating castable of Comparative Example 1. As such, many of the foamed examples in Tables 1 and 2 display better strengths in certain instances than Comparative Example 1. It can be further expected that, due to the amount of water required, the castable of Comparative Example 1 is only capable of being dry gunned. Comparative Example 1 would cause hose plugs in spraying or shotcreting.

This can partially be attributed to the use of a surfactant in Examples 1-8. In addition, although not specifically evidenced in Tables 1 and 2, the use of the sodium naphthalene sulfonate as the specific surfactant served to give stability to the foamed bubbles during the mixture. When sodium naphthalene sulfonate was replaced with other surfactants, the foamed bubbles in the mixture tended to coalesce and float during the curing process. However, it is anticipated that sodium naphthalene sulfonate could be used in tandem with other potent surfactants and dispersants to further reduce the need for water while still providing good stability in the foamed bubble network. In any respect, the use of cellulose, foaming additives, and a surfactant led to the forming of a foamed network with a ready-mix formulation that was stable under very intense vibration.

It is additionally noted that the coalescing of the foaming bubbles is also attributable to lengthy set times. Shorter set times are generally preferred to limit such coalescing.

It was also found that self-flow or free-flow of the castable is critical to strength. An example of this criticality is evidenced in Examples 3 and 7. Comparably lesser free-flow values in these examples were found to correspondingly lead to poorer physical strength than those observed in examples in which free-flow was greater. This is somewhat due to the creation of larger foamed bubbles in castables with lower free-flow, as the larger internal flaws caused by the larger foamed bubbles are susceptible to crack initiation.

Free-flow percentage may be somewhat dependent on a balance achieved between and an amount of air-entraining additive used and an amount of foaming agent used, as these examples had a doubled amount of methylcellulose from Examples 1, 2, 5, and 6, but utilized about half as much sodium dodecylbenzene sulfonate as Examples 2, 4, 6, and 8. Namely, the size of the entrained foam bubbled were directly proportional to the consistency of the castable.

While the examples featured herein demonstrate an advantage in the free-flow characteristics provided by smaller pore networks with smaller foamed bubbles, embodiments disclosed herein are not limited thereto, as it can be foreseen that, in some cases, a larger pore network could be preferable.

The favorable results achieved in the examples shown in Tables 1 and 2 can be applied across many refractory aggregate chemistries. For example, Tables 3 and 4 provided herebelow illustrate a comparison of Examples 9-12, which are four lightweight formulations, with Comparative Example 2, which is a conventional non-foamed 3300° F. low-iron insulating castable with an aggregate having a high-alumina finished aggregate chemistry of 94.8% Al₂O₃, 5.0% CaO, and 0.2% Na₂O. Notably, the cost advantage with the foamed refractory castable enhanced with the air-entraining additive and dispersants/surfactants is very significant from that of Comparative Example 2. In addition, while the aggregate/cement chemistries of Examples 9-12 remain the same, density is further lowered when an amount of methylcellulose as an air-entraining additive is increased. Density also seems to be lowered when lithium citrate is added as an accelerant.

TABLE 3

| | Examples | | | | |
|---|---|---|---|---|---|
| | | | | | Comp. |
| | 9 | 10 | 11 | 12 | Ex. 2 |
| Tabular 28 × 48M | 20 | 20 | 20 | 20 | |
| Tabular −48M | 19 | 19 | 19 | 19 | |
| Tabular −65M | 19 | 19 | 19 | 19 | |
| Calcined Alumina −325M | 8 | 8 | 8 | 8 | |
| Reactive Alumina 3.5μ | 8 | 8 | 8 | 8 | |
| Reactive Alumina 0.5μ | 11 | 11 | 11 | 11 | |
| 70% Calcium Aluminate | 15 | 15 | 15 | 15 | |
| Cement | | | | | |

PLUS Admixture

| | | | | |
|---|---|---|---|---|
| Polyethylene Glycol based | 0.15 | | 0.15 | 0.15 |
| Dispersant (surfactant) | | | | |
| Methylcellulose | 0.15 | 0.15 | 0.25 | 0.25 |
| (air-entraining additive) | | | | |
| Sodium Dodecylbenzene | 0.25 | 0.25 | 0.25 | 0.25 |
| Sulfonate (foaming agent) | | | | |
| Sodium Naphthalene | | 0.5 | | |
| Sulfonate (surfactant) | | | | |
| Lithium Citrate (accelerant) | | 0.005 | 0.015 | 0.015 |

Casting

| | | | | |
|---|---|---|---|---|
| Water % | 18.6 | 27.3 | 19.4 | 21.9 |
| Mix Time (min) | 6 | 5 | 6 | 6 |
| Final Set (hr) | | 17 | 3.6 | 3.7 |

TABLE 4

| Examples | | | | |
|---|---|---|---|---|
| | | | | Comp. |
| 9 | 10 | 11 | 12 | Ex. 2 |

After 230° F.

| | | | | | |
|---|---|---|---|---|---|
| Density (pcf) | 99 | 78 | 80 | 74 | 95 |

After 2500° F.

| | | | | | |
|---|---|---|---|---|---|
| Density (pcf) | 96 | 77 | 79 | 73 | 82 |
| AP (%) | 57 | 66 | 65 | 68 | |
| MOR (psi) | 690 | 140 | 380 | 240 | 700 |
| CCS (psi) | 1760 | 260 | 800 | 550 | 2250 |
| PLC (%) | −0.68 | −1.35 | −1.21 | −1.32 | −0.03 |
| Raw Material Cost | 1102 | 1071 | 1124 | 1147 | 1860 |
| ($/MT) | | | | | |
| % Decrease from | 40.8 | 42.4 | 39.6 | 38.3 | |
| Com. Ex. 2 | | | | | |

It is noted that, in Tables 1-4, Comparative Examples 1 and 2 yield a lower amount of PLC than that which is yielded in Examples 1-12. The greater amount of PLC evidences a higher amount of shrinkage in Examples 1-12 than in Comparative Examples 1 and 2. ASTM requirements for ready-mix refractory monolithic castables require a PLC of ±1.5% from the dried state to the maximum use temperature. Likewise, some specifications requires even more dimensional stability as the castable is heated. When making shapes and brick, some dimensional change can be planned into the final dimensional requirements of the product. However, this is not an option in the case of ready-mix monolithic refractory formulations.

Thus, in order to make ready-mix monolithic formulations that are suitable to the maximum use temperature requirements of certain applications, expansive minerals, such as kyanite, pyrophillite, silica sands, dolomite, and magnesia, are required in the refractory aggregate. An in situ expansive phase can also be applied in which magnesias and/or dolomites and alumina can form an expansive spinel phase during heating. Alumina and silica also expand when heating to form mullite.

In Tables 5 and 6 shown herebelow, Examples 13 and 14 are ready-mix monolithic refractory castable formulations incorporating expansive minerals, such as, but not limited to, kyanite, pyrophillite, and silica sands. The amount of air-entraining additive in Example 13 is different from the amount in Example 14 so that the density of the formulations could be varied.

TABLE 5

| Examples | 13 | 14 |
|---|---|---|
| Fireclay −100M | 14 | 13.5 |
| Pyrophyllite −16M | | 5 |
| Silica Sand −28M | 10 | 7.5 |
| Raw Kyanite −35M | | 2.5 |
| Raw Kyanite −325M | 20 | 10 |
| Expanded Clay Aggregate | 10 | 5 |
| Fume Silica | 10 | 7 |
| Fireclay 4 × 8M | | 4.5 |
| Fireclay −8M | 14 | 15 |
| 70% Calcium Aluminate Cement | 15 | 30 |
| Calcined Alumina −325M (high-purity alumina) | 7 | |
| Total | 100 | 100 |
| PLUS Admixture | | |
| Citric Acid (extender) | 0.1 | 0.03 |
| Methylcellulose (air-entraining additive) | 0.02 | 0.05 |
| Polypropylene Fibers (rheology modifier) | 0.05 | 0.15 |
| Polycarboxylate-based Dispersant (surfactant) | | 0.17 |
| Sodium Dodecylbenzene Sulfonate (foaming agent) | 0.5 | 0.5 |
| Lithium Fluoride (accelerant) | 0.03 | |
| Sodium Polyacrylate (dispersant/surfactant)) | 0.15 | |

TABLE 6

| Examples | 13 | 14 | Comp. Ex. 3 |
|---|---|---|---|
| Water % | 22.2 | 24 | 24 |

After 230° F.

| | | | |
|---|---|---|---|
| Density (pcf) | 68 | 82 | 83 |
| MOR (psi) | 400 | 550 | 610 |
| CCS (psi) | 1050 | 1230 | 2330 |

After 1500° F.

| | | | |
|---|---|---|---|
| Density (pcf) | 66 | 73 | 74 |
| MOR (psi) | 220 | 130 | 210 |
| CCS (psi) | 700 | 820 | 1420 |
| PLC (%) | −0.49 | −0.11 | −0.04 |

After 2500° F.

| | | | |
|---|---|---|---|
| MOR (psi) | 560 | 530 | 900 |
| CCS (psi) | 1320 | 1350 | 2430 |
| PLC (%) | −0.08 | −0.19 | −0.53 |

Chemistry

| | | | |
|---|---|---|---|
| SiO₂ | 48.1 | 43.6 | 44.5 |
| Al₂O₃ | 44.5 | 44.9 | 43.4 |
| Fe₂O₃ | 0.7 | 0.67 | 0.9 |
| TiO₂ | 1.1 | 1 | 1 |
| CaO | 4.6 | 9 | 9 |
| Alkalis | 0.6 | 0.5 | 0.9 |

Thermal Conductivity (Btu/hr · ft² · ° F./in)

| | | |
|---|---|---|
| 1500° F. | 2.8 | 3.1 |

It is noted that the density of Example 13 is less than the density of Example 14 in spite of a greater amount of air-entraining additive being included in the formulation of Example 14 than in Example 13. It is assumed that this occurred due to a greater amount of expanded clay aggregate being included in Example 13 than in Example 14, thereby serving to make the formulation in Example 13 more dense than the formulation in Example 14.

It is also identified that the density of the formulation of Example 14 is substantially the same as the density of the formulation in Comparative Example 3. However, the thermal conductivity of the formulation in Example 14 is significantly less than the thermal conductivity of the formulation in Comparative Example 3. This is due to the finer network of pores that can be achieved through the addition of air-entraining additives, dispersants, and surfactants to Example 14. This yields a lower thermal conductivity than that of a conventional lightweight aggregate.

Thermal conductivity is even further reduced when foamed masses replace bubble alumina aggregate in the ready-mix formulation. The bubble alumina aggregate castables have low densities. However, since bubble alumina does not have micro-porosity, the thermal conductivity values are higher and, thus, poorer than the thermal conductivity values of the ready-mix formulation described herein.

Regardless, density adjustment in the ready-mix formulations described herein can be achieved through performing simple adjustments to the admixture chemicals, such as the types or amounts of air-entraining additives, surfactants, dispersants, accelerants, set extenders, and foaming agents included in the ready-mix formulation.

It is noted that mineral phases may be required for certain ready-mix formulations. It is also noted that, while inclusion of expansive minerals in ready-mix formulations is typically considered to be positive, embodiments disclosed herein are not limited thereto, as pre-cast block could be conceivably formed according to aspects disclosed herein. In such a situation, no expansive phase may be necessary, because, as was noted above, pre-cast block affords an ability to design any dimensional changes into the initial cast dimensions.

While the embodiments disclosed herein are primarily directed to castable formulations, the above-referenced example mixture have suitable rheology to pump and, as such, can be installed and applied in ready-mix formulations by a variety of different pumps known to those skilled in the art. Application and installation by dry-gunning is also contemplated. In addition, embodiments disclosed herein may include formulation of pre-cast blocks and shapes using any of the combinations of binders and admixtures described above.

Moreover, while fireclay and high purity tabular alumina were used as refractory aggregates for many of the examples disclosed herein, embodiments disclosed herein are not limited thereto, as nearly any refractory aggregate would be a suitable base to apply the key aspects of the foamed lightweight monolithic refractory disclosed herein, such as, but not limited to, silicon carbides, dead burned magnesia, olivine, brown and white fused alumina, and fused silica. The embodiment disclosed herein may also be applied to mixtures already containing lightweight aggregates, including, but not limited to, expanded clays, vermiculite, and perlite.

The foamed lightweight monolithic refractory presented herein may have a low finished density that is achieved through air entrainment and without the addition of problematic aggregates that require crushing, such as perlite or vermiculite, thereby avoiding drawbacks such as alkali hydrolysis and reduced refractory ability of a finished product. Further, the finished properties of the foamed lightweight monolithic refractory castable are less affected by variations in mixing equipment and mixing time.

In addition, the air entrainment achieved in the castable of the foamed lightweight monolithic refractory may save raw material costs by formulating mixes that no longer require expensive high alumina aggregates, such as those previously mentioned herein. As little to no high alumina aggregates are contained in the foamed lightweight monolithic refractory castable, spraying and shotcreting through rotor stator style pumps, swing tube style pumps, and ball valve style pumps may be achieved without the aforementioned problematic hose plugs.

Further, the foamed lightweight monolithic refractory castable may be pumped at a much lower density than other such refractory castables can be pumped, thereby avoiding the need for dry gunning castable applications at densities less than 75 lb/ft³. Again, while dry gunning is a common refractory castable application method, the ability to use spraying and shotcreting methods in place of dry gunning methods substantially minimizes the amount of dust to which installers are exposed and the amount of rebound material loss associated with dry gunning

Moreover, the substantial exclusion of high porosity lightweight aggregates reduce the relative total amount of water required to form the foamed lightweight monolithic refractory castable. Thus, less liquid is required, thereby resulting in a foamed lightweight monolithic refractory having greater strength than conventional monolithic refractories.

In addition, air entrainment replaces the need for lightweight aggregate in the monolithic refractory mix, thereby reducing the volume of the mix. As such, air entrainment allows shipping costs of the foamed lightweight monolithic refractory mix to be reduced.

The foamed lightweight monolithic refractory is not limited to application in metal vessels used in steel production. The refractory may be applied across different chemistries while still being functional to address previously mentioned drawbacks that exist in the application of low density aggregates and high alumina aggregates.

It is conceivable that a castable such as the foamed lightweight refractory castable described herein may be realized as a mixture of a ready-mix formulation and a liquid formulation. In such a castable, it is foreseen that ready-mix formulation would not include a powder binder, such as calcium aluminate. Instead, the liquid formulation may include colloidal silica or phosphoric acid that would be applied to the ready-mix formulation prior to mixing and would act as the binder for the ready-mix formulation when mixed therewith. In such a castable, the additional application of water would not be necessary.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A foamed lightweight monolithic refractory castable, comprising:
one or more refractory aggregates as a main constituent, the refractory aggregates comprising at least one of alumina and silica;
one or more foaming additives in a range of 0.1 wt % to 3.0 wt %, the foaming additives comprising at least one of alkylbenzene sulfonates, alkene sulfonates, and hydroxylalkane sulfates;
one or more cellulosic powder air-entraining additives in a range of 0.005 wt % to 2.0 wt %;
one or more binders in a range of 1 wt % to 40 wt %; and
one or more superplasticizers in a range of 0.05 wt % to 0.5 wt %, the superplasticizers comprising at least one of sodium polyacrylates, naphthalene sulfonates, polyethylene glycols, polycarboxylates, polyacrylates, and polycarboxylate ethers.

2. The castable of claim 1, wherein the refractory aggregates further comprise at least one of kyanites, pyrophillites, silica sands, dolomites, and magnesias.

3. The castable of claim 2, wherein the refractory aggregates further comprise at least one of expanded clay aggregates, fireclays, mullites, chamottes, bauxites, and high-purity aluminas.

4. The castable of claim 1, wherein the castable is a ready-mix formulation.

5. The castable of claim 1, further comprising:
one or more accelerants in a range of 0.01 wt % to 0.25 wt %, the accelerants comprising at least one of lithium fluoride, lithium citrate, calcium hydroxide, and sodium silicate.

6. The castable of claim 1, further comprising:
one or more acidic compounds in a range of 0.03 wt % to 0.2 wt %.

7. The castable of claim 1, further comprising:
one or more rheology modifiers in a range of 0.05 wt % to 0.15 wt %, the rheology modifiers comprising at least one of polypropylene fibers, xanthan gums, and bentonite.

8. The castable of claim 1, wherein the binders comprise one or more calcium aluminate binders.

9. The castable of claim 1, wherein the cellulosic powder air-entraining additives comprise one or more of methylcellulose and methylhydroxypropylcellulose.

10. A method of applying a foamed lightweight monolithic refractory castable to a surface, the method comprising:
assembling a ready-mix formulation for the foamed lightweight monolithic refractory castable, the ready-mix formulation including one or more refractory aggregates as a main constituent, one or more foaming additives in a range of 0.1 wt % to 3.0 wt %, one or more cellulosic powder air-entraining additives in a range of 0.005 wt % to 2.0 wt %, one or more binders in a range of 1 wt % to 40 wt %, and one or more superplasticizers in a range of 0.05 wt % to 0.5 wt %, the refractory aggregates including at least one of alumina and silica, the foaming additives including at least one of alkylbenzene sulfonates, alkene sulfonates, and hydroxylalkane sulfates, the superplasticizers including at least one of sodium polyacrylates, naphthalene sulfonates, polyethylene glycols, polycarboxylates, polyacrylates, and polycarboxylate ethers;
mixing the ready-mix formulation with water to form the foamed lightweight monolithic refractory castable; and
spraying the foamed lightweight monolithic refractory castable onto the surface.

11. The method of claim 10, wherein the refractory aggregates further include at least one of kyanites, pyrophillites, silica sands, dolomites, and magnesias.

12. The method of claim 11, wherein the refractory aggregates further include at least one of expanded clay aggregates, fireclays, mullites, chamottes, bauxites, and high-purity aluminas.

13. The method of claim 10, wherein the ready-mix formulation further includes one or more accelerants in a range of 0.01 wt % to 0.25 wt %, the accelerants including at least one of lithium fluoride, lithium citrate, calcium hydroxide, and sodium silicate.

14. The method of claim 10, wherein the ready-mix formulation further includes one or more acidic compounds in a range of 0.03 wt % to 0.2 wt %,

15. The method of claim 10, wherein the ready-mix formulation further includes one or more rheology modifiers in a range of 0.05 wt % to 0.15 wt %, the rheology modifiers including at least one of polypropylene fibers, xanthan gums, and bentonite.

16. The method of claim 10, wherein a percentage of water by weight of the foamed lightweight monolithic refractory castable is in a range of 15 wt % to 35 wt %.

17. The method of claim 10, further comprising, after the mixing:
setting the foamed lightweight monolithic refractory castable in a range of 2 hours to 24 hours.

18. The method of claim 17, further comprising:
curing the sprayed foamed lightweight monolithic refractory castable on the surface.

19. The method of claim 10, wherein the spraying of the foamed lightweight monolithic refractory castable comprises shotcreting the foamed lightweight monolithic refractory castable

20. The method of claim 10, wherein the binders comprise one or more calcium aluminate binders.
